(19) United States
(12) Patent Application Publication
(10) Pub. No.: US 2008/0253082 A1
(43) Pub. Date: Oct. 16, 2008

(54) Cooling system with flexible heat transport element

(76) Inventors: Jeffrey A. Lev, Cypress, TX (US); Paul J. Doczy, Cypress, TX (US); Mark S. Tracy, Tomball, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/786,952

(22) Filed: Apr. 12, 2007

(51) Int. Cl. G06F 1/20; B21D 51/16

(52) U.S. Cl. 361/687; 29/890.09; 361/700

(57) ABSTRACT

A computing device cooling system comprising a heat transport element for transferring heat from a heat generating component of a computing device to a heat dissipation element of the computing device, the heat transport element having at least one flexible section to facilitate bending of the heat transport element.

### BACKGROUND

Computing devices, such as laptop or notebook computers, can generate high thermal loads during operation. In order to reduce or eliminate the likelihood of heat-related damage to the computing device, computing devices comprise cooling systems to dissipate the thermal loads. One type of system incorporates a heat transport element, such as a heat pipe, to transport heat away from sources of thermal energy within the computing device (e.g., transporting heat from a central processing unit to a heat exchanger). However, when orienting the heat pipe within the computing device (i.e., when configuring the heat pipe to extend between and thermally connect the central processing unit with the heat exchanger), the heat pipe is susceptible to damage resulting from aligning, positioning and/or thermally coupling the heat pipe to the central processing unit and/or other heat producing elements to the heat exchanger.

### BRIEF DESCRIPTION OF THE DRAWINGS

FIG. 1 is a diagram of a perspective view of an interior area of a computing device employing an embodiment of a cooling system with a flexible heat transport element; and

FIG. 2 is a diagram illustrating a portion of the flexible heat transport element of FIG. 1.

### DETAILED DESCRIPTION OF THE DRAWINGS

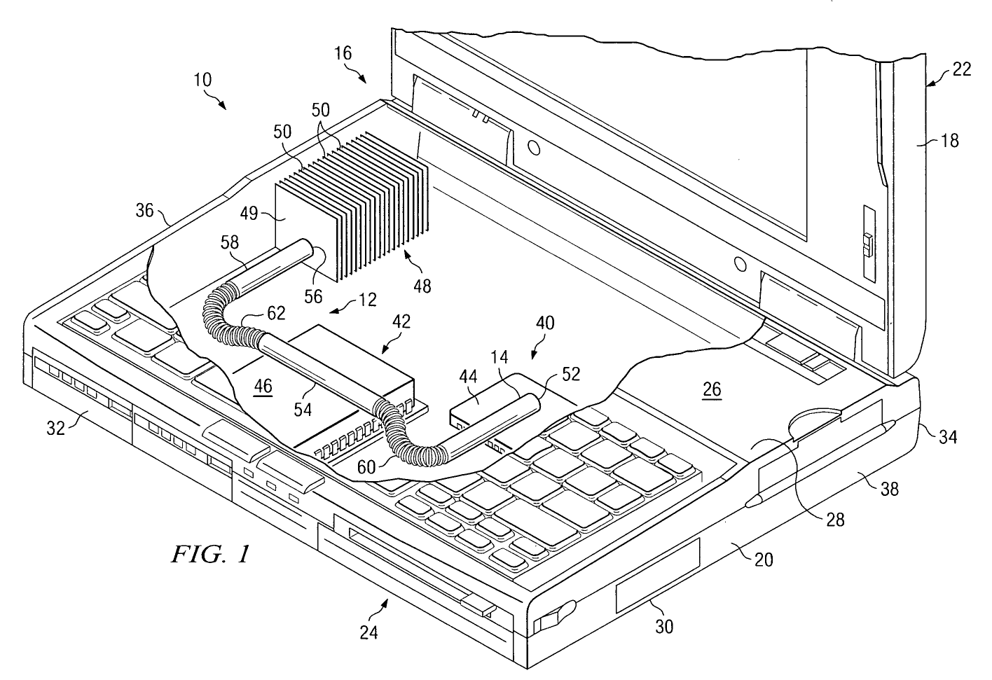

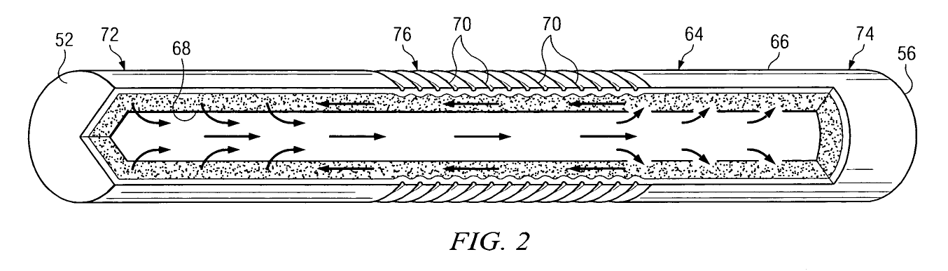

Various embodiments and the advantages thereof are best understood by referring to FIGS. 1 and 2, like numerals being used for like and corresponding parts of the various drawings.

FIG. 1 is a diagram of a perspective view of an interior area of a computing device 10 employing an embodiment of a cooling system 12 having a flexible heat transport element 14. In the embodiment illustrated in FIG. 1, computing device 10 comprises a laptop or notebook computer 16; however, it should be understood that computing device 10 may comprise any type of computing device such as, but not limited to, a tablet personal computer, a personal digital assistant, a desktop computer, a gaming device, or any other type of portable or non-portable computing device. In the embodiment illustrated in FIG. 1, computing device 10 comprises a display member 18 rotatably coupled to a base member 20. Display member 18 and base member 20 each comprise a housing 22 and 24, respectively, formed having a number of walls. For example, housing 24 comprises a top wall 26 defining a working surface 28, a bottom wall 30, a front wall 32, a rear wall 34 and a pair of sidewalls 36 and 38.

In the embodiment illustrated in FIG. 1, cooling system 12 is disposed within housing 24 of base member 20 and is configured to dissipate and/or otherwise remove thermal energy from an internal area of base member 20 generated by one or more heat generating components, such as components 40 and 42, disposed in base member 20. Components 40 and 42 may comprise a variety of different types of components of computing device 10 (e.g., processors, graphics chips, or any other device used in the operation of computing device 10). In the embodiment illustrated in FIG. 1, components 40 and 42 comprise a northbridge chipset 44 and a central processing unit (CPU) 46. It should be understood that cooling system 12 may be otherwise located (e.g., alternatively or additionally, within housing 22 of display member 18 to dissipate heat generated from components disposed within display member 18).

In the embodiment illustrated in FIG. 1, heat transport element 14 is configured to transport heat from components 40 and 42 to a heat dissipation element 48 configured as a heat exchanger 49. In the embodiment illustrated in FIG. 1, heat exchanger 49 comprises a plurality of fins 50 to facilitate thermal energy dissipation from heat exchanger 49. In the embodiment illustrated in FIG. 1, component 40 is coupled to an end 52 of heat transport element 14 and component 42 is coupled to an intermediate/middle portion 54 of heat transport element 14 for transferring thermal energy generated by components 40 and 42 toward an end 56 of heat transport element 14 and thus heat exchanger 49. Heat transport element 14 may comprise any type of thermally conductive element capable of transferring heat from computer operational components 40 and 42 toward heat exchanger 49. In the embodiment illustrated in FIG. 1, heat transport element 14 comprises a heat pipe 58 preferably filled with a vaporizable liquid to increase heat transfer performance.

In the embodiment illustrated in FIG. 1, heat transport element 14 comprises bellowed intermediate sections 60 and 62 to facilitate bending and/or directional reconfiguration of heat transport element 14 in one or more different directions. According to some embodiments, bellowed sections 60 and 62 enable portions of heat transport element 14 to be bent and/or manipulated into a variety of different directions relative to other portions of heat transport element 14, thereby facilitating forming element 14 into a variety of different shapes/directions, including, for example, S-curves, bending in multiple planes (e.g., vertical and horizontal planes) and/or bent/configured in any other obscure shape. Accordingly, bellowed sections 60 and 62 substantially reduce and/or eliminate the likelihood of heat transport element 14 breaking and/or crimping, and thus making it non-functional and/or less efficient, that may otherwise result from connecting heat transport element 14 to different components, especially if the different components lie in different planes. For example, heat transport element 14 comprises bellowed section 60 to enable heat transport element 14 to be bent and/or deformed in a plurality of planes (e.g., a generally horizontal plane and a generally vertical plane) to enable horizontal and vertical alignment of heat transport element 14 with components 40 and 42 and/or to accommodate dimensional variations between components 40 and 42. In the embodiment illustrated in FIG. 1, heat transport element 14 comprises two bellowed sections 60 and 62; however, it should be understood that heat transport element 14 may comprise a greater or fewer number of bellowed sections 60 and/or 62. Further, it should be understood that bellowed sections 60 and/or 62 may be otherwise located along heat transport element 14.

FIG. 2 is a diagram illustrating a portion of the flexible heat transport element 14 of FIG. 1. In the embodiment illustrated in FIG. 2, heat transport element 14 comprises a metal tube 64 such as, for example, an aluminum or copper tube, comprising an outer wall 66 and an inner lining 68 formed of a wick-like material disposed on an inner surface of wall 66. In FIG. 2, heat transport element 14 is configured to hold an amount of fluid therein to enable heat to transfer between ends 52 and 56 by evaporative means (FIG. 1). In the embodiment illustrated in FIG. 2, bellowed section 60 comprises a plurality of spaced apart grooves 70 disposed around the circumference of heat transport element 14 to facilitate movement/bending of heat transport element 14 along at least two degrees of freedom to enable movement in multiple axial directions. It should be understood that bellowed section 60 may be otherwise configured (e.g., only partially disposed around the circumference of the heat transport element 14). According to some embodiments, heat transport element 14 comprises an evaporator section 72, a condenser section 74, and an adiabatic section 76 disposed between evaporator section 72 and condenser section 74. In FIGS. 1 and 2, bellowed section 60 is disposed within adiabatic section 76 and is formed on wall 66 and the inner surface of wall 66 is coated with a wicking material. In FIG. 2, bellowed section 60 is described. However, it should be understood that bellowed section 62 may be similarly configured.

Thus, embodiments of cooling system 12 provide a flexible heat transport element 14 to enable heat transport element 14 to be easily bent and/or deformed to a variety of different angles and/or directions to accommodate spacing variations and/or different locations/sizes of components 40 and 42 to which element 14 is to be connected while substantially reducing and/or eliminating the likelihood of heat transport element 14 breaking and/or crimping from making such connections.

What is claimed is:

1. A computing device cooling system, comprising:
a heat transport element for transferring heat from a heat generating component of a computing device to a heat dissipation element of the computing device, the heat transport element having at least one flexible section to facilitate bending of the heat transport element.

2. The system of claim 1, wherein the at least one flexible section comprises a bellowed section.

3. The system of claim 1, wherein the at least one flexible section comprises a plurality of grooves formed on the heat transport element.

4. The system of claim 1, wherein the at least one flexible section is disposed between a condenser section and an evaporator section of the heat transport element.

5. The system of claim 1, wherein the at least on flexible section comprises a plurality of spaced apart grooves formed in at least an outer wall of the heat transport element.

6. The system of claim 5, wherein the plurality of spaced apart grooves extend around a circumference of the heat transport element.

7. The system of claim 1, wherein at least a portion of the heat transport element is bendable relative to another portion of the heat transport element in at least two degrees of freedom.

8. A method of manufacturing a computing device cooling system, comprising:
providing a heat transport element in a computing device for transferring heat from a heat generating component to a heat dissipation element, the heat transport element having at least one flexible section to facilitate bending of the heat transport element.

9. The method of claim 8, further comprising providing a bellowed section on the at least one flexible section.

10. The method of claim 8, further comprising forming a plurality of grooves on the at least one flexible section.

11. The method of claim 8, further comprising disposing the at least one flexible section between a condenser section and an evaporator section of the heat transport element.

12. The method of claim 8, further comprising forming a plurality of spaced apart grooves disposed on at least an outer wall of the heat transport element.

13. The method of claim 12, further comprising forming the plurality of spaced apart grooves extending around a circumference of the heat transport element.

14. The method of claim 8, further comprising providing the at least flexible heat transport element bendable relative to another portion of the heat transport element in at least two degrees of freedom.

15. A computing device cooling system, comprising:
a means for transporting heat from a heat generating means of a computing device to a means for dissipating heat from the computing device, the heat transporting means having at least one flexible means for facilitating bending of the heat transporting means.

16. The system of claim 15, wherein the flexible means comprises at least one bellowed section.

17. The system of claim 15, wherein the flexible means comprises a plurality of grooves formed on the heat transporting means.

18. The system of claim 17, wherein the plurality of grooves extends around a circumference of the heat transporting means.
